(19) United States
(12) Patent Application Publication
(10) Pub. No.: US 2010/0171275 A1
(43) Pub. Date: Jul. 8, 2010

(54) Collet with multiple keys way

(76) Inventor: Bill Nguyen, Carson, CA (US)

Correspondence Address: BILL NGUYEN, 16536 SAN PEDRO ST., CARSON, CA, 90746, US

(21) Appl. No.: 12/319,109

(22) Filed: Jan. 2, 2009

(51) Int. Cl. B23B 31/10

(52) U.S. Cl. 279/4.09

(57) ABSTRACT

The present invention collet is provided with multiple Keys way for quick select key way, balancing and reduced Vibration of the conventional machines or CNC lathes spindle At high RPM (revolution per minute).

### BACKGROUND OF THE INVENTION

### FIELD OF THE INVENTION

The present invention relates to the field of the collet 5C, 3J, 16C, or the like for the conventional or CNC lathe Collet chuck spindle.

It is one objective of the present invention is provided the Collet with more than one keys way for quick lock set screw When insert the screw into the an anti-rotation key way when install the Collet into the lathe collet chuck spindle.

It is second objective of the present invention is provided The collet with the plurality of circumferentially Longitudinally multiple keys way and equal spaced between keys Way to provide the best spindle balancing and reduced spindle Vibration at high RPM. (Revolution per minute)

### DESCRIPTION OF THE DRAWINGS

FIG. 1 is a side elevational view,front,rear,and a cross sectional cut away A A view, in order to illustrate two short keys way and one longer key way to the end of collet chucks.

FIG. 2 is a side elevational view,front,rear,and a cross sectional cut away A A view, in order to illustrate three short keys way of collet chucks.

FIG. 3 is a side elevational view,front,rear,and a cross sectional cut away A A view, in order to illustrate three short keys way and one longer key way to the end of collet chucks.

FIG. 4 is a side elevational view,front,rear,and a cross sectional cut away A A view, in order to illustrate four short keys way of collet chucks.

### DETAILED DESCRIPTION OF THE INVENTION

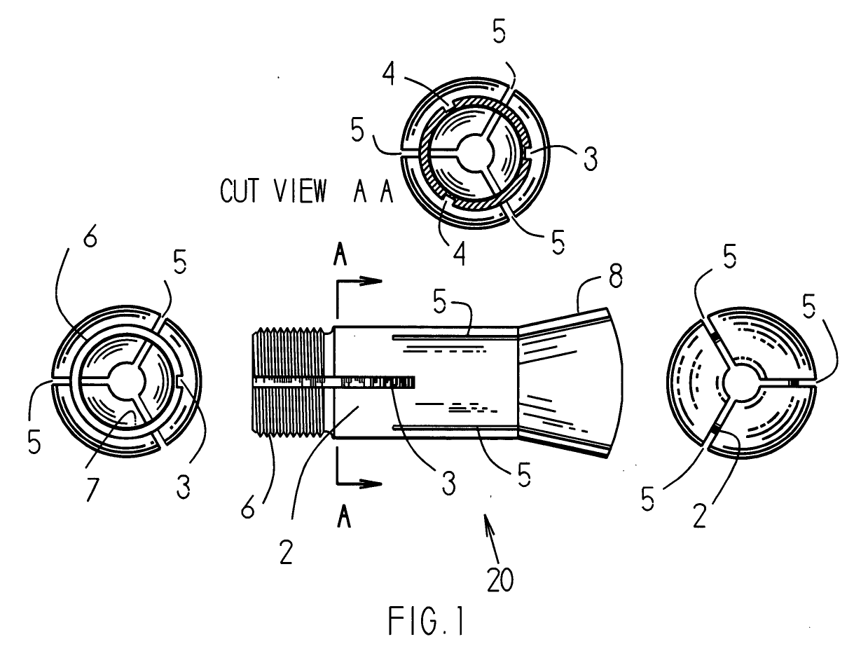

Referring now to the drawings in FIG. 1 there is shown the present invention, which comprises a collet 20 for use with a spindle of the conventional or CNC lathes, with a tubular body portion 2 and the flared tapered surfaces 8, the tapered front end of the collet 20 has the plurality of the radially slots 5 extending from the central, longitudinally directed body shank 2 as is partial shown, a longest anti rotation key way 3 as is shown and two shorter anti rotation key way 4 as is partially shown in cross cut view A A, an external threaded 6 at the rear end thereof to receive the draw-tube of the lathes spindle for push and pull to open or close the collet and the internal threaded 7 to receive the collet stopper.

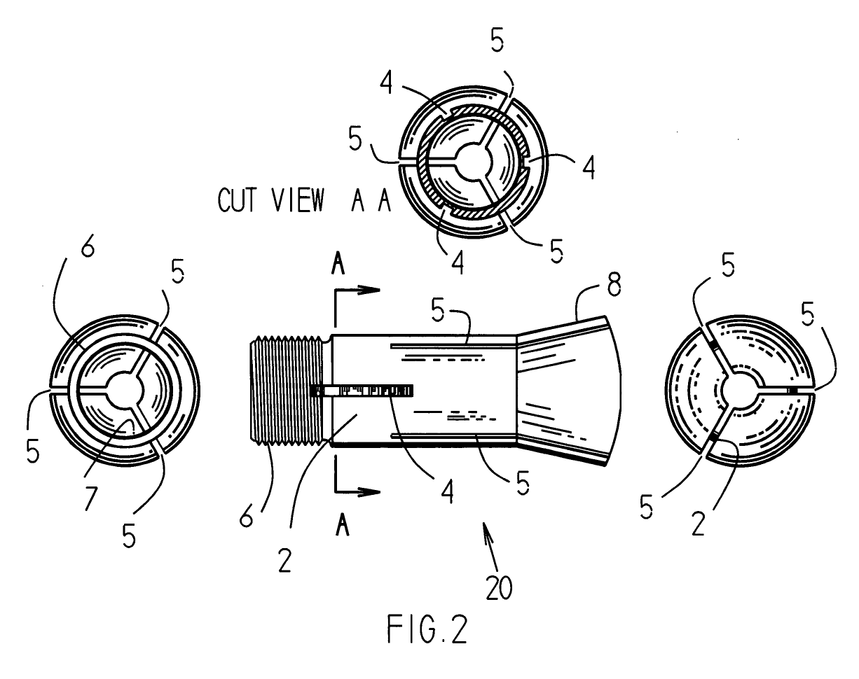

In FIG. 2 is similar to FIG. 1, except in FIG. 2, having the equal plurality of circumferentially spaced longitudinally anti rotation keys way 4, are not pass through the external threaded 6 as is shown to prevent unbalanced CNC lathe machine spindle at high RPM.

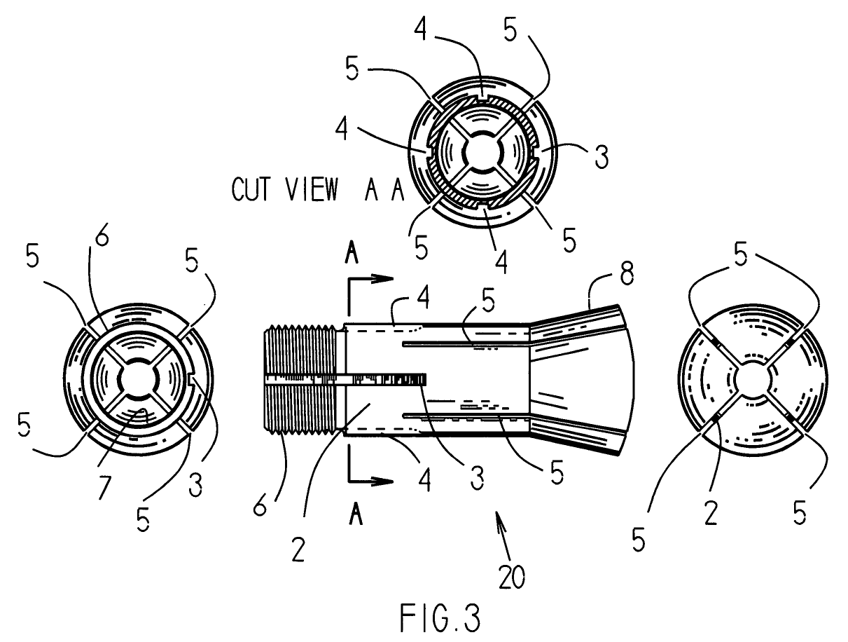

In FIG. 3 is similar to FIG. 1, except in FIG. 3 having a Longest anti rotation key way 3 as is shown and three shorter Anti rotation keys way 4 as is partially shown in cross cut view A A.

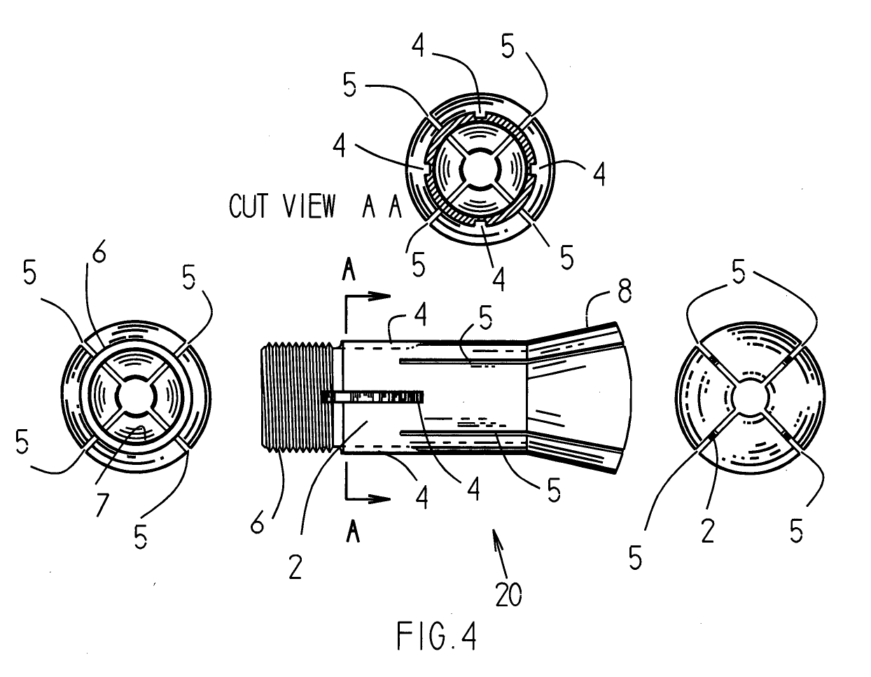

In FIG. 4 is similar to FIG. 3, except in FIG. 4 having the equal plurality of Circumferentially 90 degree spaced apart, longitudinally anti rotation keys way 4, are not pass through the external threaded 6 as is shown to prevent unbalanced CNC lathe machine spindle at high RPM.

What is claimed is:

1. A collet has the plurality anti rotation keys way, wherein one key way longitude passes through the external threaded at the end.

2. A collet with the plurality (two keys way) of circumferentially 180 degree spaced apart anti rotation keys way.

3. A collet with the plurality (three keys way) of circumferentially 120 degree spaced apart anti rotation keys way.

4. A collet with the plurality (four keys way) of circumferentially 90 degree spaced apart anti rotation keys way.
